(19) United States
(12) Patent Application Publication
(10) Pub. No.: US 2009/0073366 A1
(43) Pub. Date: Mar. 19, 2009

(54) LIQUID CRYSTAL DISPLAY DEVICE AND MANUFACTURING METHOD THEREFOR

(76) Inventor: Yukio Kurozumi, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/297,379

(22) PCT Filed: Mar. 9, 2007
(86) PCT No.: PCT/JP2007/054704

§ 371 Date: Oct. 16, 2008

(30) Foreign Application Priority Data
Apr. 21, 2006 (JP) 2006-118168

(51) Int. Cl. G02F 1/1333; G02F 1/1339; G02F 1/1343

(52) U.S. Cl. 349/139; 349/155; 349/187

(57) ABSTRACT

Due to spacer particles 31, a gap of a predetermined size is provided between a pair of transparent substrates 10, 20 which are arranged parallel and opposite to each other. The spacer particles 31 are arranged on a set surface 19, which is formed on the surface of the TFT substrate 10 that faces the CF substrate 20 and specifically is formed in a grid-like light blocking area 30 thereof. The set surface 19 extends over the substantially entire width of the light blocking area 30, so as to form a flat surface that is substantially at the same level over its entire area. Thereby, the spacer particles 31 are infallibly arranged in the set area 30, and consequently the cell gap of the predetermined size can be reliably secured.

### TECHNICAL FIELD

The present invention relates to a liquid crystal display device including spacer particles for keeping a gap between transparent substrates, and to a manufacturing method therefor.

### BACKGROUND ART

A liquid crystal display device has a construction shown in FIG. 7, in which liquid crystal 103 is disposed between a transparent glass substrate 100, on which TFTs (Thin Film Transistors) are formed, and a transparent glass substrate 101, on which RGB color sections 102 are distributed and thereby which forms a color filter. In the liquid crystal display device, the thickness or cell gap of the liquid crystal layer should be uniform over the entire area of the transparent substrates 100, 101, in order to prevent unevenness, or the like, of display in the liquid crystal display device. For example, a construction described in Patent Document 1 has been produced, in which spherical spacer particles 104 as means for uniformizing the cell gap are arranged between the transparent substrates so that the gap therebetween can be uniform over the entire area of the transparent substrates. Patent Document 1: JP-A-2005-10412

### DISCLOSURE OF THE INVENTION

### Problem to be Solved by the Invention

In the above liquid crystal display device, a grid-like light blocking area 106 is formed along a black light shielding film 105 provided as a divider between the rgb color sections 102. On the TFT transparent substrate 100, a set surface 108 is formed on the top surface of a gate electrode wire 107, which is smaller than the light blocking area 106 in width and is provided along the light blocking area 106. The spacer particles 104 are applied on the set surface 108, as shown by solid lines in FIG. 7.

Thin-film Display electrodes 109 are arranged on the respective sides of the gate electrode wire 107 so as to correspond to the color sections 102. As shown in FIG. 7, a depression 110, larger than the diameter of the spacer particles 104, may be formed between the gate electrode wire 107 and the display electrode 109. In this case, the spacer particles 104 can deviate from the set surface 108 resulting in falling into the depression 110, as shown by two-dot chain lines in FIG. 7. When the spacer particles 104 are thus located below the set surface 108, the cell gap between the transparent substrates 100, 101 cannot be secured to be a predetermined, size at that location.

The present invention was made in view of the foregoing circumstances, and an object thereof is to arrange spacer particles infallibly in a set area and thereby reliably fulfill a function for securing a cell gap.

### Means for Solving the Problem

As a means for achieving the above object, a liquid crystal display device according to the present invention includes a pair of transparent substrates, and a spacer particle arranged in a grid-like light blocking area provided on the pair of transparent substrates, so as to keep a gap of a predetermined size between the pair of transparent substrates. Further included is liquid crystal disposed between the pair of transparent substrates. A set surface, on which the spacer particle is arranged, is formed on the surface of at least one transparent substrate of the pair of transparent substrates that faces the other transparent substrate. The liquid crystal display device is characterized in that the set surface extends over the substantially entire width of the light blocking area so as to form a flat surface that is substantially at the same level over its entire area.

According to the present invention, the set surface extends over the substantially entire width of the light blocking area so as to form a flat surface that is substantially at the same level over its entire area. Thereby, the spacer particle is infallibly arranged in the set area, and consequently the cell gap of a predetermined size can be reliably secured.

A liquid crystal display device of the present invention is further characterized in that a raised portion, which is smaller than the light blocking area in width and is arranged along the light blocking area, is provided on one transparent substrate of the pair of transparent substrates. A raising layer in vicinity to a side edge of the raised portion is formed, on the one transparent substrate, and the set surface is formed on a surface, which is on the side of the liquid crystal and extends over the raised portion and the raising layer.

According to the present invention, the set surface of large width can be secured due to the raising layer being formed, although the raised portion is small in width.

A liquid crystal display device of the present invention is further characterized in that a raised portion, which is arranged along the light blocking area, is provided on one transparent substrate of the pair of transparent substrates. The raised portion includes a wide portion having a width substantially equal to the full width of the light blocking area, and the set surface is formed on a surface, which is on the side of the liquid crystal and extends over the wide portion.

According to the present invention, although the raised portion is small in width, a portion thereof that corresponds to the set area provided for the spacer particle is widened, and thereby the set surface of large width can be secured.

A liquid crystal display device of the present invention is further characterized in that the raised portion is formed of an electrode wire to be connected to a drive element.

According to the present invention, arrangement of the spacer particle can be enabled by utilizing an electrode wire to be connected to a drive element.

A liquid crystal display device of the present invention is further characterized in that a color filter, on which a plurality of color sections separated by a black light shielding film provided along the light blocking area are arranged, is provided on one transparent substrate of the pair of transparent substrates. The raised portion is formed of an electrode wire, which is arranged on the other of the transparent substrates so as to traverse the color section when viewed from the top.

According to the present invention, arrangement of the spacer particle can be enabled by utilizing an electrode wire that is arranged on the other of the transparent substrates so as to traverse the color section.

A liquid crystal display device of the present invention is further characterized in that an auxiliary capacitor electrode wire for an auxiliary capacitor is provided on one transparent substrate of the pair of transparent substrates, and the raised portion is formed of the auxiliary capacitor electrode wire.

According to the present invention, arrangement of the spacer particle can be enabled by utilizing an auxiliary capacitor electrode wire provided for an auxiliary capacitor.

A liquid crystal display device of the present invention is further characterized in that a plurality of spacer particles as the spacer particle included in droplets of ink are applied to the set surface, and are fixed to the set surface due to drying of the ink. A recess having a depth smaller than the diameter of the spacer particle is formed on an area of the set surface to which droplets of ink are applied.

According to the present invention, any of the plurality of spacer particles applied to the set surface can fall in the recess, resulting in a core particle located therein. The other spacer particles are sorbed by the core particle, as the ink dries. Thereby, the spacer particles are prevented from moving outside of the set surface.

On the other hand, a manufacturing method for a liquid crystal display device according to the present invention is characterized by forming a set surface on one transparent substrate of a pair of transparent substrates which are arranged parallel and opposite to each other. The pair of transparent substrates include a grid-like light blocking area, and the set surface is formed in the light blocking area so as to extend over the substantially entire width of the light blocking area and form a flat surface that is substantially at the same level over its entire area. The manufacturing method is further characterized by applying the spacer particle to the set surface, and placing one of the pair of transparent substrates on the other while sandwiching the spacer particle therebetween, so that a gap of a predetermined size is formed therebetween due to the spacer particle. The manufacturing method is further characterized by dropping or encapsulating liquid crystal in the gap between the pair of transparent substrates which are arranged opposite to each other.

According to the present invention, the set surface extends over the substantially entire width of the light blocking area so as to form, a flat surface that is substantially at the same level over its entire area. Thereby, the spacer particle is infallibly arranged in the set area, and consequently the cell gap of a predetermined size can be reliably secured.

### BRIEF DESCRIPTION OF THE DRAWINGS

FIG. 1 is a plan view of a TFT substrate according to an embodiment 1;

FIG. 2 is an enlarged sectional view of FIG. 1 along the line X-X;

FIG. 3 is a partially enlarged sectional view showing a set surface according to an embodiment 2;

FIG. 4 is a plan view of a TFT substrate according to an embodiment 3;

FIG. 5 is an enlarged sectional view of FIG. 4 along the line Y-Y;

FIG. 6 is a plan view of a TFT substrate according to an embodiment 4; and

FIG. 7 is a sectional view showing a set surface of the prior art.

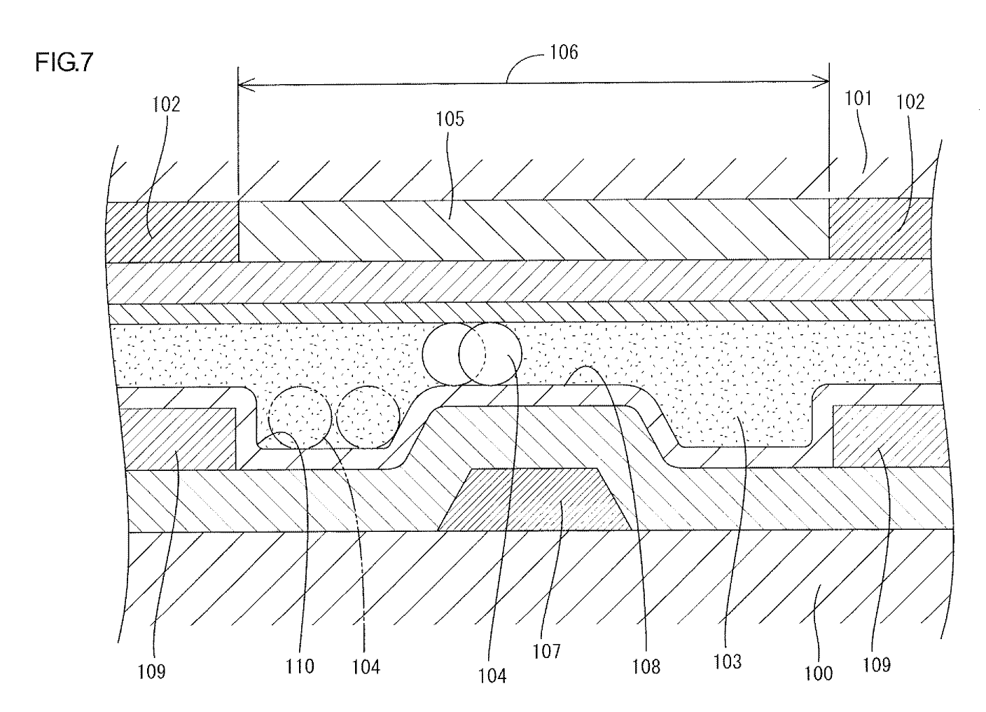

### EXPLANATION OF SYMBOLS

10: TFT substrate (Transparent substrate)

12: Gate electrode wire (Raised portion)

14: Drive element

18: Recess

19: Set surface

20: CF substrate (Transparent substrate)

21: Color filter

22: Color section

23: Black light shielding film

30: Light blocking area

31: Spacer particle

32: Liquid crystal

42, 50, 60: Set surface

61: Auxiliary capacitor electrode wire (Raised portion)

### BEST MODE FOR CARRYING OUT THE INVENTION

### Embodiment 1

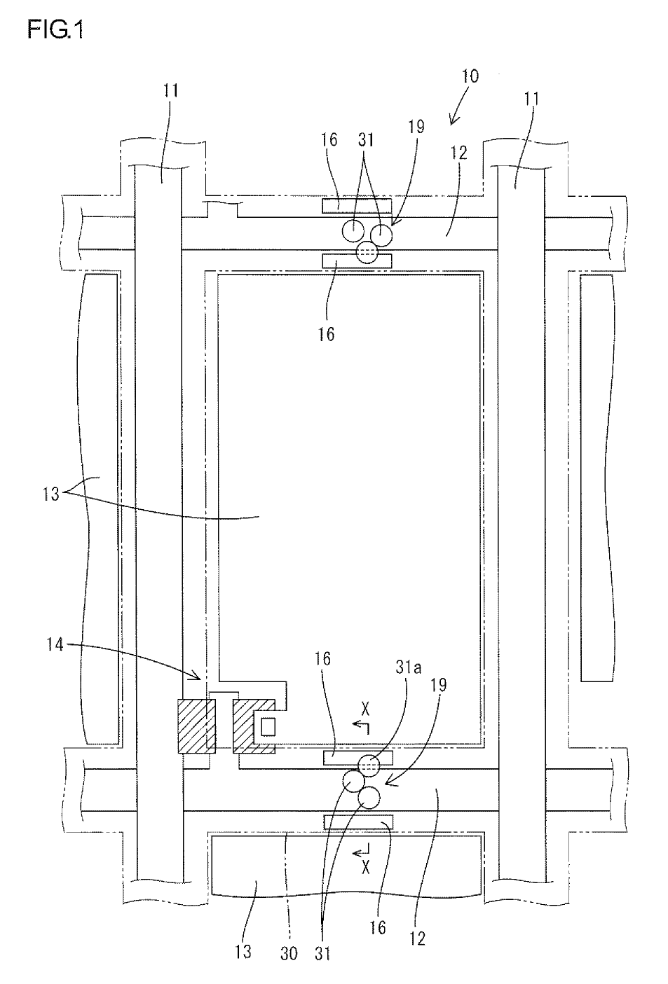

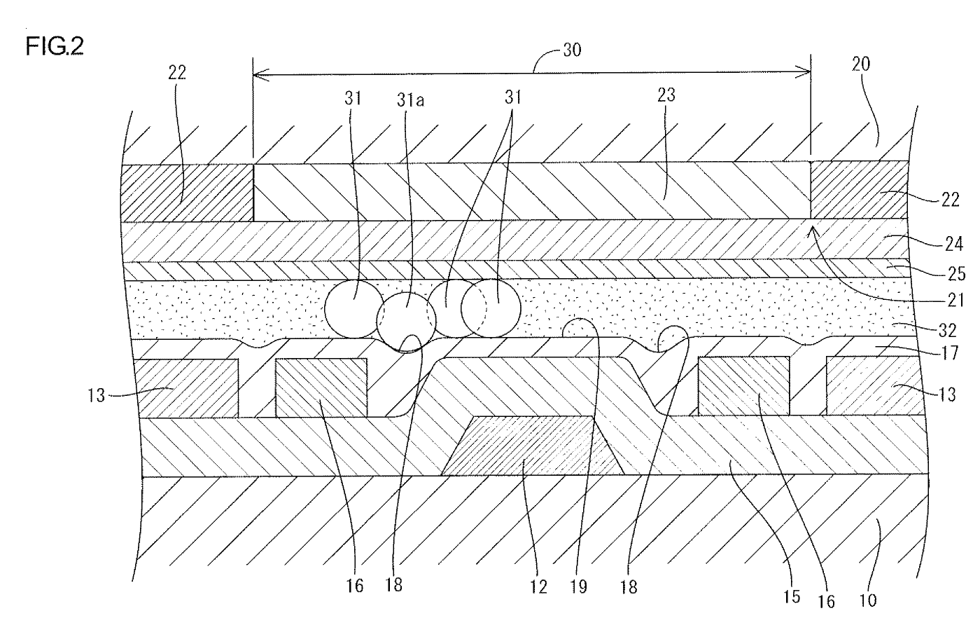

An embodiment 1 according to the present invention will be hereinafter explained with reference to FIGS. 1 and 2. In a liquid crystal display device of the present embodiment, a pair of transparent glass substrates, i.e., a TFT substrate 10 and a CF substrate 20 are arranged parallel and opposite to each other. Spacer particles 31 are disposed between the substrates 10, 20, so that the gap (i.e., cell gap) between the substrates 10, 20 is kept uniform over the entire area thereof. The gap between the substrates 10, 20 is filled with liquid crystal 32.

On the surface of the CF substrate 20 that faces the TFT substrate 10, a color filter 21 is provided, on which rectangular thin-film color sections 22 of three primary colors, i.e., Red (R), Green (G) and Blue (B), are laterally aligned and separated by a black light shielding film 23 (or black matrix) arranged in a grid pattern. On the surfaces of the color filter 21 and the black light shielding film 23 (which face the TFT substrate 10), a common electrode 24 is formed of a transparent ITO (Indium Tin Oxide) film, and an alignment film 25 is formed on the surface of the common electrode 24.

The grid area, of the CF substrate 20, on which the black light shielding film. 23 is formed, corresponds to (or, when viewed from the top, is overlapped with) a wired grid area (or lattice frame) on the TFT substrate 10 described below, on which source electrode wires 11 and gate electrode wires 12 (corresponding to a raised portion of the present invention) are arranged. The grid areas on the respective TFT substrate 10 and CF substrate 20, which correspond to (or, when viewed from the top, are overlapped with) the area of the black light shielding film 23, form a light blocking area 30 that is uninvolved in image display on the liquid crystal display device.

On the surface of the TFT substrate 10 that faces the CF substrate 20, a plurality of vertical source electrode wires 11 are arranged at regular intervals, while a plurality of horizontal gate electrode wires 12 are arranged at regular intervals, as shown in FIG. 1. The source electrode wires 11 and the gate electrode wires 12 are arranged along the above-described grid-like light blocking area 30 (and within the light blocking area 30). A substantially-rectangular display electrode 13 formed of a transparent ITO (Indium Tin Oxide) film is arranged in each of many rectangular areas (one of them is shown in FIG. 1) within the lattice frame that is formed by the source electrode wires 11 and the gate electrode wires 12. Further, a drive element 14, formed of a TFT (Thin Film Transistor) connected to the source electrode wire 11 and the gate electrode wire 12, is provided at a corner of each rectangular area within the lattice frame.

On the surface of the TFT substrate 10 (that faces the CF substrate 20), the gate electrode wires 12 having a predetermined thickness are formed by a photolithographic method, as shown in FIG. 2. The gate electrode wire 12 is smaller than the light blocking area 30 in width. The gate electrode wire 12 is positioned substantially at the across-the-width center of the light blocking area 30. The surface of the TFT substrate 10 and the surfaces of the gate electrode wires 12 are covered with an insulating film 15 such as a gate insulator. On the surface of the insulating film 15, the area, that corresponds to the gate electrode wire 12 or is overlapped with the gate electrode wire 12 when viewed from the top, is locally raised with a level difference. On the surface of the insulating film 15, the above-described display electrodes 13 are formed on the lower areas (i.e., areas not corresponding to (or, when viewed from the top, not overlapped with) the gate electrode wires 12). The peripheral edges of the display electrode 13 are positioned to correspond substantially to the side edges of the light blocking area 30. Therefore, a gap of a size corresponding to half of the difference between widths of the light blocking area 30 and the gate electrode wire 12 is formed between the side edge of the gate electrode wire 12 and the outer periphery of the display electrode 13.

On the surface of the insulating film 15, a raising layer 16 is formed on an area corresponding to the gap between the gate electrode wire 12 and the display electrode 13 (or an area overlapped with the gap, when viewed from the top). The raising layer 16 is arranged along the side edge of the gate electrode wire 12 and the outer periphery of the display electrode 13, and is positioned in the longitudinal direction of the gate electrode wire 12 to be substantially at a location intermediate between two adjacent source electrode wires 11. By a photolithographic method, the raising layers 16 are formed of the same material and in the same process as the source electrode wires 11, but are not connected to a circuit for image display. The surface of the raising layer 16 is level with the surface of a portion of the insulating film 15 corresponding to the gate electrode wire 12 (or overlapped with the gate electrode wire 12, when viewed from the top).

The areas of the surface of the insulating film 15 corresponding to the gate electrode wires 12 (or overlapped with the gate electrode wires 12, when viewed from the top), the surfaces of the display electrodes 13, the surfaces of the raising layers 16 and the gaps therebetween are covered with a protective film 17 referred to as Pas (or a passivation film). The surface of the protective film 17 is substantially at the same level (or substantially even) at least in the light blocking area 30 and the vicinity thereof. Specifically, the area corresponding the gate electrode wire 12 is level with the area corresponding to the raising layer 16. However, a groove-like recess 18 having a depth smaller than the outer diameter (or diameter) of the spacer particle 31 is formed on the boundary division between the area corresponding to (or, when viewed from the top, overlapped with) the gate electrode wire 12 and the area corresponding to (or, when viewed from the top, overlapped with) the raising layer 16. On the surface of the protective film 17 (that faces the CF substrate 20), the areas corresponding to (or, when viewed from the top, overlapped with) a pair of raising layers 16 and the area corresponding to (or, when viewed from the top, overlapped with) a portion of the gate electrode wire 12 sandwiched between the raising layers 16 are substantially at the same level and collectively form a substantially-rectangular set surface 19. The set surface 19 includes a pair of recesses 18. The set surface 19 is within the light blocking area 30 so as to extend over the substantially entire width of the light blocking area 30.

A plurality of spacer particles 31 can be arranged on the set surface 19. The spacer particle 31. is formed of a spherical synthetic-resin body, and the surface thereof is coated with an adhesive (not shown). In a manufacturing process, the spacer particles 31 included in ink (not shown) are ejected from an ink-jet apparatus (not shown), so as to be applied to the top of the set surface 19. At the time, ink droplets each of which includes a plurality of spacer particles 31, are applied to an area of the set surface 19 that includes the recesses 18.

After applied, each droplet of the ink gradually evaporates and dries while holding a single-droplet state due to surface tension, and consequently the radius of each ink droplet gradually becomes smaller. As the radius of each ink droplet decreases, the plurality of spacer particles 31 included in the ink move on the set surface 19 so as to approach one another, and one of the spacer particles 31 falls in each recess 18. The spacer particle 31 can be contained in the recess 18 so that its upper portion protrudes upward from the set surface 19 and its movement in a direction parallel to the set surface 19 (or parallel to the TFT substrate 10) is restricted, and thereby acts as a core particle 31a. After the core particle 31a has located in the recess 18, the other spacer particles 31 remaining on the set surface 19 approach the core particle 31a as the ink droplets become smaller, resulting in contact (or abutment) with the core particle 31a and thereby being positioned. When the ink has completely evaporated, the core particle 31a is fixed, into the recess 18 by the adhesive applied on the surface of the particle, while each spacer particle 31 is fixed to the set surface 19 by the adhesive applied on the surface of the particle.

Even if the droplets of ink applied to the set surface 19 are partially located outside of the set surface 19 (i.e., outside of the light blocking area 30, and therefore in the areas corresponding to (or, when viewed from the top, overlapped with) the display electrodes 13), the stray spacer particles 31 are drawn to the core particle 31a that is contained in the recess 18 with restriction of movement, as the ink droplets become smaller. Therefore, they can be finally located within the set surface 19, resulting in fixation thereon.

When the spacer particles 31 are thus located (or fixed) on the surface of the TFT substrate 10, the CF substrate 20 is then placed (or attached) on the TFT substrate 10 so that the spacer particles 31 are sandwiched therebetween. In the resultant structure, the gap (or cell gap) between the substrates 10, 20 is kept uniform over the entire area of the substrates 10, 20, due to spacer particles 31 fixed on a plurality of set surfaces 19. Consequently, the substrates 10, 20 can be held parallel to each other with high accuracy. The liquid crystal 32 is then dropped or encapsulated in the gap between the substrates 10, 20, using a liquid crystal dispensing apparatus or a liquid crystal filling apparatus (not shown). Thus, the manufacture of the liquid crystal display device proceeds.

As described above, in the present embodiment, the set surface 19 for arrangement of spacer particles 31 extends over the substantially entire width of the light blocking area 30 so as to form a flat surface that is substantially at the same level over its entire area. Thereby, the spacer particles 31 are infallibly arranged in the set area, and consequently the cell gap of a predetermined size can be reliably secured.

The gate electrode wire 12 that partly forms the basis for the set surface 19 is smaller than the light blocking area 30 in width. However, the raising layers 16 are formed proximally to the side edges of the gate electrode wire 12, so that the raising layers 16 together with the gate electrode wire 12 form the basis for the set surface 19. Thereby, the set surface 19 of large width can be secured, although the gate electrode wire 12 is small in width.

In the present embodiment, the set surface 19 is formed by utilizing a gate electrode wire 12 that is to be connected to a drive element 14. Thereby, arrangement of the spacer particles 31 is enabled.

Further, in the present embodiment, a plurality of spacer particles 31 included in droplets of ink are applied to the set surface 19, and are fixed on the set surface 19 due to drying of the ink. The recesses 18 having a depth smaller than the diameter of the spacer particle 31 are formed on the area of the set surface 19 to which ink droplets are applied. Therefore, one spacer particle 31 of the plurality of spacer particles 31 applied to the set surface 19 can fall in each recess 18, resulting in a core particle 31a located therein. The other spacer particles 31 are sorbed by the core particle 31a as the ink dries. Thereby, the spacer particles 31 are prevented from moving outside of the set surface 19.

### Embodiment 2

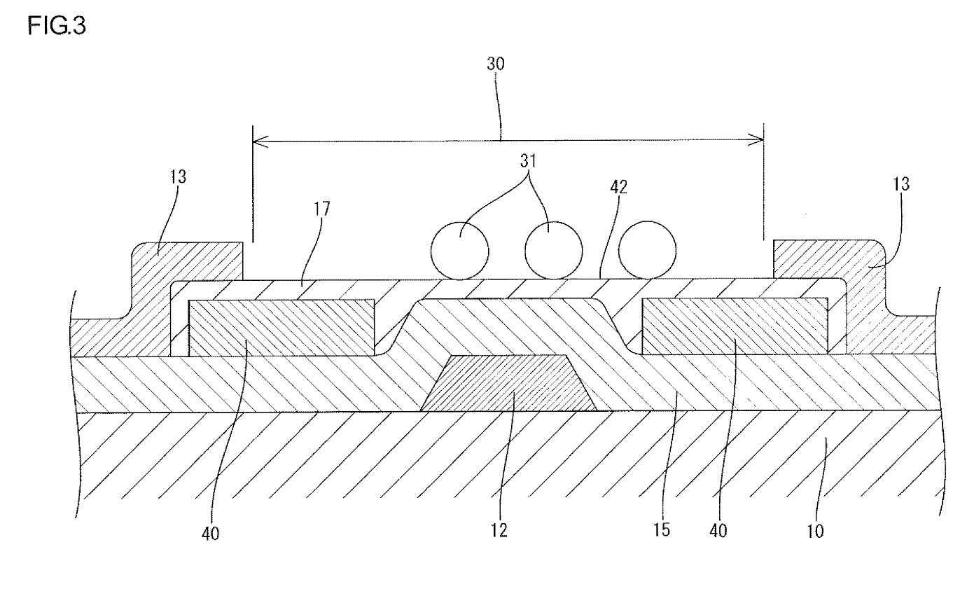

Next, an embodiment 2 of the present invention will be explained with reference to FIG. 3. in the present embodiment 2, the construction of a raising layer 40 differs from that of the above embodiment 1. The other constructions are similar to the above embodiment 1. Therefore, the same constructions are designated by the same symbols, and explanations for the construction, operation and effects thereof are omitted.

The raising layers 40 of the present embodiment 2 are formed of the same material as insulating layers provided on the TFT substrate 10 and the CF substrate 20. Examples of the insulating layers are an i-layer (made of a-Si, i.e., amorphous silicon) and/or an n+ layer (made of μC-Si, i.e., micro-crystal silicon). The raising layer 40 is larger than the raising layer 16 of the embodiment 1 in width. The edge portion of the raising layer 40 on the opposite side of the gate electrode wire 12 extends out of the light blocking area 30. On the surface of the portion of the raising layer 40 outside of the light blocking area 30, the peripheral edge portion of the display electrode 13 is placed on a protective film 17 provided thereon. On the surface of the protective film 17, the area sandwiched between two adjacent display electrodes 13, i.e., the area corresponding to the gate electrode wire 12 and the areas corresponding to (or, when viewed from the top, overlapped with) the portions of the raising layers 40 within the light blocking area 30, forms a set surface 42 for arrangement of spacer particles 31.

In the case of conductor raising layers, a capacitance may be formed, between the gate electrode wire 12 and the display electrode 13 through the raising layer, if the distance between the raising layer and the gate electrode wire 12 is set to be short. However, in the present embodiment, the raising layers 40 are made of an insulating material. Thereby, the raising layer 40 and the gate electrode wire 12 in mutual proximity can be achieved, while preventing a capacitance formed between the gate electrode wire 12 and the display electrode 13. Accordingly, the recess 18 of the embodiment 1, formed in the boundary division between the gate electrode wire 12 and the raising layer 16, is not provided in the present embodiment 2. Therefore, the set surface 42 is flat over its entire area.

### Embodiment 3

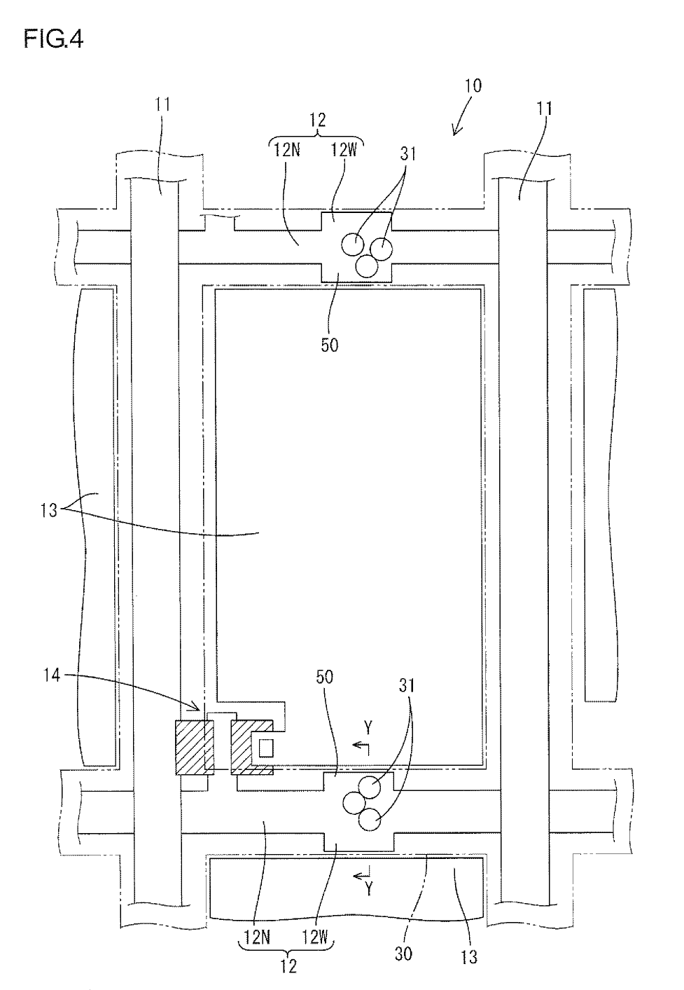

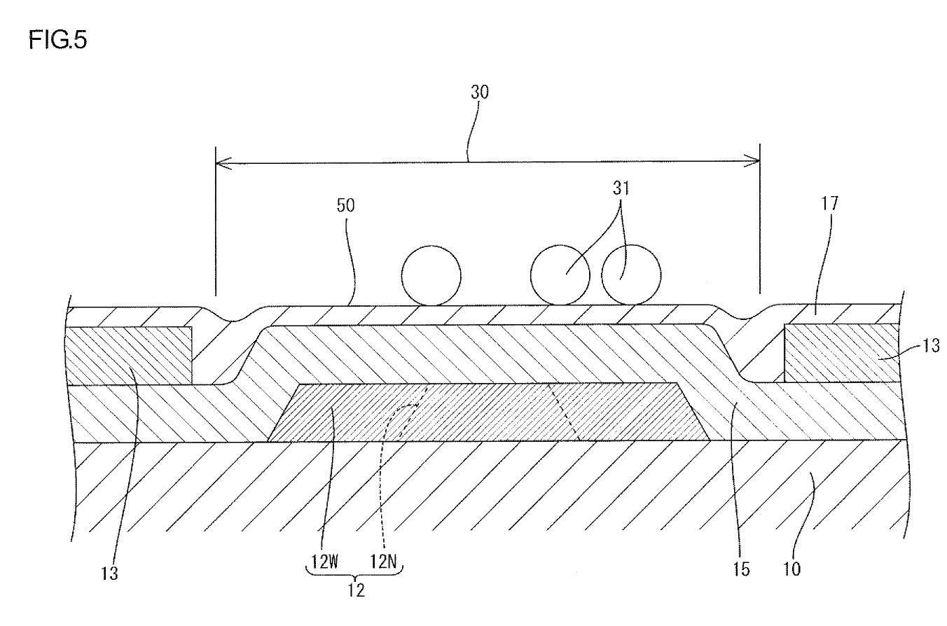

Next, an embodiment 3 of the present invention will be explained with reference to FIGS. 4 and 5. In the present embodiment 3, the construction of a set surface 50 differs from that of the above embodiment 1. The other constructions are similar to the above embodiment 1. Therefore, the same constructions are designated by the same symbols, and explanations for the construction, operation and effects thereof are omitted.

In the present embodiment 3, a substantially-rectangular wide portion 12W is formed on a gate electrode wire 12, so as to extend over a certain longitudinal area thereof and bulge (or protrude) outward from the side edges thereof. The portions 12N of the gate electrode wire 12 except the wide portion 12W are smaller than the light blocking area 30 in width, as in the embodiment 1. The width of the wide portion 12W is set to be substantially equal to that of the light blocking area 30 (or slightly smaller than the width of the light blocking area 30). On the surface of the protective film 17, the area corresponding to (or, when viewed from the top, overlapped with) the wide portion 12W forms a substantially-rectangular set surface 50 that is flat (or even) over its entire area. In the present embodiment, although the gate electrode wire 12 is smaller than the light blocking area. 30 in width, securing of a set surface 50 having a large width (or a large area) is achieved by locally widening the gate electrode wire 12. In the present embodiment 3, raising layers 16 or 40 as in the embodiment 1 or 2 are not provided, and a portion corresponding to a recess 18 as in the embodiment 1 is not formed on the set surface 50.

### Embodiment 4

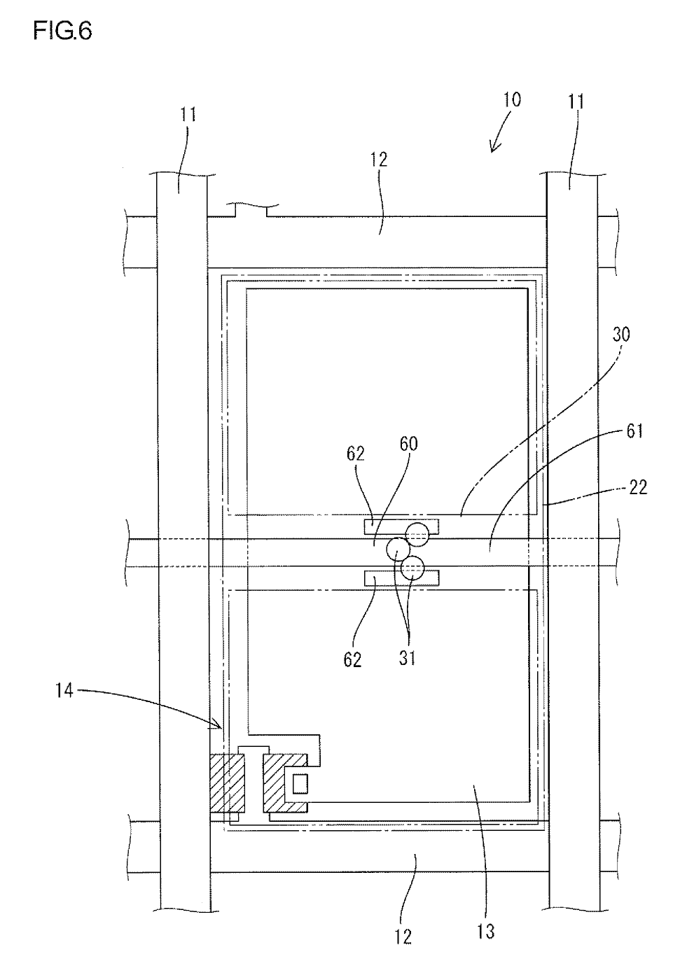

Next, an embodiment 4 of the present invention will be explained with reference to FIG. 6. In the present embodiment 4, the construction of a set surface 60 differs from that of the above embodiment 1. The other constructions are similar to the above embodiment 1. Therefore, the same constructions are designated by the same symbols, and explanations for the construction, operation and effects thereof are omitted.

As described above, a color filter 21, which includes a plurality of color sections 22 separated by a grid-like black light shielding film 23 (black matrix), is formed on the CF substrate 20. Auxiliary capacitor electrode wires 61 for auxiliary capacitors (e.g., storage capacitors or additional capacitors) are provided on the TFT substrate 10, each of which is arranged to traverse color sections 22. The area corresponding to (or, when viewed from, the top, overlapped with) an auxiliary capacitor electrode wire 61 is also provided as a light blocking area 30. In the light blocking area 30, a pair of raising layers 62 are formed along the side edges of the auxiliary capacitor electrode wire 61. The pair of raising layers 62 and the area of the auxiliary capacitor electrode wire 61 sandwiched between the raising layers 62 form the basis for a substantially-rectangular set surface 60.

In the present embodiment 4, the set surface 60 is formed by utilizing an auxiliary capacitor electrode wire 61 that is arranged to traverse color sections 22. Alternatively, a set surface may be formed by utilizing an auxiliary capacitor electrode wire that is arranged so as not to traverse color sections 22. Further, a set surface may be provided by locally widening an auxiliary capacitor electrode wire 61 as in the embodiment 3, instead of forming raising layers 62.

### Other Embodiments

The present invention is not limited to the embodiments explained in the above description made with reference to the drawings. The following embodiments may be included in the technical scope of the present invention, for example.

(1) In the above embodiment 1, the raising layers are formed in the same process as the source electrode wires. However, the raising layers are not limited to being thus formed, but rather may be formed of i-layers, n+ layers, or gate electrode wires, for example.

(2) In the above embodiments, the gate electrode wires are provided as electrode wires to be connected to drive elements. Alternatively, the source electrode wires may be thus used instead.

(3) In the above embodiments, the spacer particles are arranged on either the TFT substrate or the CF substrate. However, the spacer particles may be arranged on both of the TFT substrate and the CF substrate. In this case, the spacer particles on the CF substrate should be arranged so as not to overlap or interfere with the spacer particles on the TFT substrate.

(4) In the above embodiments, explanation was made for the case in which drive elements are formed of TFTs. However, the present invention can be applied to the case In which drive elements are formed of elements other than TFTs such as MIM (Metal Insulator Metal) elements.

(5) In the above embodiment 1, the recesses are formed on the set surface. However, the recesses may be eliminated from the set surface.

1-8. (canceled)

9. A liquid crystal display device comprising:
a pair of transparent substrates;
a spacer particle arranged in a grid-like light blocking area provided on said pair of transparent substrates, so as to keep a gap of a predetermined size between said pair of transparent substrates;
liquid crystal disposed between said pair of transparent substrates; and
a set surface formed on a surface of at least one transparent substrate of said pair of transparent substrates that faces the other transparent substrate, said spacer particle being arranged on said set surface;
wherein said set surface extends over a substantially entire width of said light blocking area so as to form a flat surface that is substantially at a same level over its entire area.

10. A liquid crystal display device comprising: a pair of transparent substrates;
a spacer particle arranged in a grid-like light blocking area provided on said pair of transparent substrates, so as to keep a gap of a predetermined size between said pair of transparent substrates;
liquid crystal disposed between said pair of transparent substrates;
a raised portion provided on one transparent substrate of said pair of transparent substrates, said raised portion being smaller than said light blocking area in width and being arranged along said light blocking area;
a raising layer formed on said one transparent substrate and arranged in vicinity to a side edge of said raised portion; and
a set surface formed on a surface that is on a side of said liquid crystal and extends over said raised portion and said raising layer, said spacer particle being arranged on said set surface;
wherein said set surface extends over a substantially entire width of said light blocking area so as to form a flat surface that is substantially at a same level over its entire area.

11. A liquid crystal display device comprising:
a pair of transparent substrates;
a spacer particle arranged in a grid-like light blocking area provided on said pair of transparent substrates, so as to keep a gap of a predetermined size between said pair of transparent substrates;
liquid crystal disposed between said pair of transparent substrates; a raised portion provided on one transparent substrate of said pair of transparent substrates and arranged along said light blocking area, said raised portion including a wide portion that has a width substantially equal to a full width of said light blocking area; and
a set surface formed on a surface that is on a side of said liquid crystal and extends over said wide portion, said spacer particle being arranged on said set surface;
wherein said set surface extends over a substantially entire width of said light blocking area so as to form a flat surface that is substantially at a same level over its entire area.

12. A liquid crystal display device as in claim 10, wherein said raised portion is formed of an electrode wire to be connected to a drive element.

13. A liquid crystal display device as in claim 11, wherein said raised portion is formed of an electrode wire to be connected to a drive element.

14. A liquid crystal display device as in claim 10, wherein:
a color filter is provided on the other transparent substrate of said pair of transparent substrates, and a plurality of color sections separated by a black light shielding film provided along said light blocking area are arranged on said color filter; and
said raised portion is formed of an electrode wire, which is arranged on said one transparent substrate so as to traverse said color section when viewed from the top.

15. A liquid crystal display device as in claim 11, wherein:
a color filter is provided on the other transparent substrate of said pair of transparent substrates, and a plurality of color sections separated by a black light shielding film provided along said light clocking area are arranged on said color filter; and said raised portion is formed of an electrode wire, which is arranged on said one transparent substrate so as to traverse said color section when viewed from the top.

16. A liquid crystal display device as in claim 10, wherein:
an auxiliary capacitor electrode wire for an auxiliary capacitor is provided on said one transparent substrate; and said raised portion is formed of said auxiliary capacitor electrode wire.

17. A liquid crystal display device as in claim 11, wherein:
an auxiliary capacitor electrode wire for an auxiliary capacitor is provided on said one transparent substrate; and
said raised portion is formed of said auxiliary capacitor electrode wire.

18. A liquid crystal display device as in claim 9, wherein:
a plurality of spacer particles as said spacer particle included in a droplet of ink are applied to said set surface, and are fixed to said set surface due to drying of the ink; and
a recess having a depth smaller than a diameter of said spacer particle is formed on an area of said set surface to which a droplet of ink is applied.

19. A liquid crystal display device as in claim 10, wherein:
a plurality of spacer particles as said spacer particle included in a droplet of ink are applied to said set surface, and are fixed to said set surface due to drying of the ink; and
a recess having a depth smaller than a diameter of said spacer particle is formed on an area of said set surface to which a droplet of ink is applied.

20. A liquid crystal display device as in claim 11, wherein:
a plurality of spacer particles as said spacer particle included in a droplet of ink are applied to said set surface, and are fixed to said set surface due to drying of the ink; and
a recess having a depth smaller than a diameter of said spacer particle is formed on an area of said set surface to which a droplet of ink is applied.

21. A manufacturing method for a liquid crystal display device, comprising:
forming a set surface on one transparent substrate of a pair of transparent substrates which are arranged parallel and opposite to each other, wherein said pair of transparent substrates include a grid-like light blocking area, and said set surface is formed in said light blocking area so as to extend over a substantially entire width of said light blocking area and form a flat surface that is substantially at a same level over its entire area;
applying a spacer particle to said set surface;
placing one of said pair of transparent substrates on the other while sandwiching said spacer particle there between, so that a gap of a predetermined size is formed there between due to said spacer particle; and
filling said gap with liquid crystal.
